(19) United States
(12) Patent Application Publication
(10) Pub. No.: US 2004/0048748 A1
(43) Pub. Date: Mar. 11, 2004

(54) Pesticide-free weed and grass killer

(76) Inventor: Herb Friend, Rockville Centre, NY (US)

Correspondence Address: Herb Friend, 72 Allen Road, Rockville Centre, NY, 11570, US

(21) Appl. No.: 10/237,297

(22) Filed: Sep. 10, 2002

(51) Int. Cl. A01N 59/00; A01N 37/00; A01N 25/04; A01N 25/16

(52) U.S. Cl. 504/320; 504/364; 504/116.1

(57) ABSTRACT

A pesticide-free weed and grass killer. More particularly, the invention is a non-selective, water-based herbicidal formulation that is EPA exempt, as all ingredients are Generally Regarded As Safe. Importantly, in the preferred mode, the invention utilizes sodium lauryl sulfate as a surfactant to accomplish the foregoing. The formulation further utilizes 3% to 10% of acetic acid, 2% to 10% of NaCl, and 1% to 5% Sorbitol, with the aforementioned wetting agent present in a range of 0.01% to 0.25%. Therefore, in total, the present invention provides an effective and natural herbicidal composition to be applied to vegetative growth to achieve a complete kill thereof.

### BACKGROUND OF THE INVENTION

1. Field of the Invention

The present invention is a pesticide-free weed and grass killer. More particularly, the invention is a non-selective, water-based herbicidal formulation that is EPA exempt, as all ingredients are “Generally Regarded As Safe.”

2. Description of the Prior Art

Numerous innovations for herbicides have been provided in the prior art that are described as follows. Even though these innovations may be suitable for the specific individual purposes to which they address, they differ from the present invention as hereinafter contrasted. The following is a summary of those prior art patents most relevant to the invention at hand, as well a description outlining the differences between the features of the present invention and those of the prior art.

U.S. Pat. No. Re. 34,594, invented by Christians, entitled “Preemergence Weed Control Using Corn Gluten Meal”

The patent to Christians describes corn gluten meal as a natural preemergence herbicide.

U.S. Pat. No. 5,074,901, invented by Alderman, entitled “Composition Derived From Sea Water For The Treatment Of Vegetation And Its Method Of Operation”

The Alderman invention describes a liquor useful as a natural herbicide and also, when diluted with water, useful as a plant micronutrient.

U.S. Pat. No. 4,626,271, invented by Gleason, entitled “Cyanobacterin Herbicide”

The Gleason invention relates to an herbicidal composition comprising cyanobacterin and a surfactant. Cyanobacterin obtained from extracts of blue-green algae or chemical synthesis when combined with a sticker such as non-ionic surfactants provides an herbicidal formulation which will adhere to green plants in a herbicidally effective amount.

U.S. Pat. No. 5,290,749, invented by Christians et al., entitled “Preemergence Weed Control Using Plant Protein Hydrolysate”

In the Christians et al. invention, a method of selectively inhibiting growth of unwanted plants in a plot of soil is provided comprising the application of a plant protein hydrolysate to the plot of soil, prior to emergence of the unwanted plants and at a concentration of application which inhibits the growth of the unwanted plants.

U.S. Pat. No. 4,361,435, invented by Meyers et al., entitled “Copper And Amine Based Aquatic Herbicides”

The Meyers et al. invention relates to herbicidal and algaestatic and algaecidal compositions and use thereof comprising copper salts; both soluble acid salts as copper sulfate, chloride, nitrate, acetate, sulfamate, gluconate, citrate, etc. and basic copper salts such as basic copper sulfate, cupric hydroxide, basic copper carbonate, basic copper chloride and the like for a method for treating bodies of water to arrest or eliminate the growth of algae and aquatic weeds by giving a more efficient algaestat, algaecide and/or herbicide, when the copper salts or insoluble basic copper salts are used as a complex with an alkylene diamine, such as ethylenediamine, propylenediamine and substituted derivatives of these; or poly (aminoalkylene).sub.n —NH.sub.2 wherein n is from 2 to 4, 5 or 6 such as diethylene triamine, triethylene tetraamine, tetraethylene pentaamine, dipropylene triamine, or mixtures of each of these with the others, including diamines, such as aminoethyl ethanolamine and mixtures of same with the other amines; in the complex a high copper content in useful form is achieved and the effect of the complex on the weeds is prolonged and noteworthy; as against previous copper compounds which require the use of an organic herbicide such as 1,1′ ethylene-2,2′ dipyridinium dibromide, (DIQUAT.sup.R) with the copper compound to produce satisfactory herbicidal action at safe and economic copper levels, the herein disclosed and claimed copper and alkylene diamine complex is used alone for aquatic weed control.

U.S. Pat. No. 4,755,207, invented by Bannon, entitled “Synergistic Mycoherbicidal Compositions”

In the patent to Bannon synergistic herbicidal compositions comprise a non-phytotoxic crop oil, a surfactant, and a hydrophobic mycoherbicide spore. This composition is useful to control undesirable plants, generally referred to as weeds, by application of the composition with standard agricultural spray equipment to the undesirable plant. Exemplified herein is the application of Alternaria cassiae spores in mixture with well-known non-phytotoxic crop oil:surfactant products to the well-known weed, sicklepod. The results, as shown in Table 1, are dramatically synergistic and, thus, presage a high degree of practical utility for the subject invention in weed control.

U.S. Pat. No. 4,392,883, invented by Iori, entitled “Herbicidal Composition And Process”

The patent to Iori describes an herbicidal composition which is characterized by the combination use as active ingredients of a thiocarbamate derivative of formula I: ##STR1## wherein one of X and Y is a hydrogen and the other is a chlorine and 4-amino-3-methyl-6-phenyl-1,2,4-triazin-5(4H)-one of the formula: ##STR2## Also provided is a process of inhibiting the growth of unwanted plants by applying the herbicidal composition to the plants or to the soil where the plants are grown.

U.S. Pat. No. 4,199,347, invented by Pilgram, entitled “Cycloalkanecarboxanilide Derivative Herbicides”

The patent to Pilgram describes compounds of the formula ##STR1## wherein Y is C.sub. 1-3 alkyl; R.sup.1 is an optionally substituted hydrocarbyl group and R.sup.2 is alkyl or halogen, are useful as herbicides.

U.S. Pat. No. 6,124,240, invented by Bieringer, entitled “Combinations Of Sulfonylurea Herbicides And Safeners”

The patent to Bieringer describes Phytotoxic side effects of the herbicide of the formula (A1) (flupyrsulfuron) or herbicidal salts thereof ##STR1## on crops, preferably cereals and maize, can be prevented by combining the herbicides with safeners (B) from the group a) compounds of the formulae (B1) and (B2), ##STR2## in which W is a divalent heterocyclic radical from the group of the partially unsaturated or heteroaromatic five-membered heterocycles having 1 to 3 hetero ring atoms of the type N and O, at least one nitrogen atom and at the most one oxygen atom being present in the ring, and X, n, Z, R*, and W are as defined in claim 1, and/or b) compounds of the group of the hormonal growth regulators (auxins).

U.S. Pat. No. 5,488,027, invented by Bauer, entitled “Herbicide Safener Combinations Containing Sulfonylurea Or Imidazolinone Herbicides”

The patent to Bauer describes herbicidal compositions which contain an effective amount of A) one or more herbicides selected from the group comprising sulfonylureas and imidazolinones and B) one or more safeners selected from the group comprising B1) phenyl-substituted imidazole-, imidazoline- and triazolecarboxylic acid derivatives and the benzyloxazolinecarboxylic acid derivatives and/or B2) quinolin-8-oxyalkanecarboxylic acid derivatives, with the exception of combinations of imidazolinones with compounds of the formula B2. The compositions are particularly suitable for protecting plants against phytotoxic secondary effects of sulfonylurea herbicides and imidazolinone herbicides. In the case of the imidazolinone herbicides, the invention also relates to a method of protecting corn plants, by applying post-emergence an effective amount of a quinolin-8-oxyalkanecarboxylic acid derivative together with the imidazolinone herbicide to the plants or the area under cultivation.

U.S. Pat. No. 5,573,997, invented by Lojek, entitled “Herbicidal composition consisting essentially of acetic acid and citric acid”

The patent to Lojek describes an aqueous herbicidal composition consisting essentially of about 1-5 wt. % acetic acid and 0.25 to 2.5 wt. % citric acid in a ratio of acetic:citric of about 4:1 to about 2:1.

U.S. Pat. No. 4,529,797, invented by Peik, entitled “Heteropolysaccharide S-198”

In the patent to Peik, a novel polysaccharide S-198 is disclosed composed of principally carbohydrate, 9-12% protein, and 2-4% O-acyl groups (calculated as O-acetyl). The carbohydrate portion comprises about 13-18% glucuronic acid and the neutral sugars mannose, glucose, and rhamnose in the approximate molar ratio 1:2:2. This polysaccharide is produced by a new Alcaligenes species ATCC 31853, in a suitable fermentation medium.

U.S. Pat. No. 3,869,277, invented by Berger, entitled “Herbicidal Compositions and Methods”

The patent to Berger describes compositions possessing post-emergence herbicidal activity and contain as the active ingredient L-trans-2-amino-4-(2-aminoethoxy)-3-butenoic-acid or acid addition salts thereof are described.

U.S. Pat. No. 6,218,336, invented by Coleman entitled “Enhanced Herbicides”

The Coleman invention provides improved herbicide compositions, methods of making the compositions and methods of controlling plant growth. The subject invention relates to combining fatty acid based and other herbicides with succinic acid, succinic acid derivatives and other additives such as those having essentially no herbicidal activity to increase the activity of the herbicide and provide methods of controlling plant growth by applying a combination of a herbicidal fatty acid with succinic acid and/or succinic acid derivative chemicals and/or other additives. In addition to the use of succinic acid, combining other Krebs cycle acids with herbicides can also provide beneficial effects. Concentrations of herbicides and additives applied to plants in accordance with the invention can include compositions involving 0.1 to 30% herbicide, preferably 0.5 to 15% herbicide and additive and more preferably 1-8% herbicide. The ratio of herbicide, such as fatty acid herbicide to activity enhancing additives can be from 1:10 to 20:1, preferably 1:1 to 20:1, most preferably 1:1 to 5:1.

U.S. Pat. No. 4,213,776, invented by Giilk, entitled “Herbicidal concentrate containing ketone and amide solvents”

The patent to Giilk describes emulsifiable concentrated solution containing an ester of a chlorinated phenoxy alkanoic acid herbicide and a herbicidally active aryl alkyl urea compound, dissolved in a combination of a water-immiscible ketone solvent and a water-miscible amide solvent.

U.S. Pat. No. 5,705,455, invented by Lojek, entitled “Synergistic herbicidal composition comprising vinegar and lemon juice”

The patent to Lojek describes an herbicidal composition, which can be formulated for selective or total kill of vegetation of as a growth regulator, comprises a synergistic combination of acetic acid and citric acid.

Generally, the prior patents illustrate various natural and organic herbicides, including those utilizing corn gluten meal; those utilizing particular forms of liquor; those relying upon the usage of cyanobacteria as a surfactant; and those using copper salts and copper sulfates to accomplish their intended purposes.

Unlike the above, the present invention uniquely utilizes sodium lauryl sulfate as a surfactant, embodied within a formulation with acetic acid, NaCl, and Sorbitol, in the previously-determined ranges noted herein.

### SUMMARY OF THE INVENTION

As noted, the present invention is a pesticide-free weed and grass killer. More particularly, the invention is a water-based herbicidal formulation that is EPA exempt, as all ingredients are Generally Regarded As Safe.

Importantly, in the preferred mode, the invention utilizes sodium lauryl sulfate as a surfactant to accomplish the foregoing. The formulation further utilizes 3% to 10% of acetic acid, 2% to 10% of NaCl, and 1% to 5% Sorbitol, with the aforementioned wetting agent present in a range of 0.01% to 0.25%. Therefore, in total, the present invention provides an effective and natural herbicidal composition to be applied to vegetative growth to achieve a complete kill thereof.

In light of the foregoing, it is generally an object of the present invention to provide a weed and grass killer that is natural and EPA Exempt.

It is also an object of the invention to provide a compound that is highly effective in killing unwanted weeds and grasses, without potential health risks to users and nearby persons or animals.

It is a further object of the invention to provide a formula that is nature-friendly, as usage of the compound will not pollute the environment.

It is an additional object of the invention to provide an herbicide that provides positive results very quickly, such as in hours rather than days, allowing children and pets to play in the areas shortly after usage thereof.

Finally, it is an object of the present invention to provide an effective, natural formula that may be dispensed in a variety of convenient, traditional means, including a variety of spray bottles and containers.

The novel features which are considered characteristic for the invention are set forth in the claims. The invention itself, both as to its construction and its method of operation, together with additional objects and advantages thereof, will be best understood from the following description of the embodiments.

### DETAILED DESCRIPTION OF THE PREFERRED EMBODIMENT

As noted, the present invention is a pesticide-free weed and grass killer. More particularly, the invention is a water-based herbicidal formulation that is EPA exempt, as all ingredients are Generally Regarded As Safe.

Therefore, as previously indicated, the present invention utilizes sodium lauryl sulfate as a surfactant to accomplish the foregoing. In the preferred mode, the formulation further utilizes 3% to 10% of acetic acid, 2% to 10% of NaCl, and 1% to 5% Sorbitol, with the aforementioned wetting agent present in a range of 0.01% to 0.25%. It should be noted that, for the purposes of example, these active and inert ingredients can be found in common items such as salad dressings, vitamins, toothpaste and shampoo. Sodium lauryl sulfate in particular is a foaming agent found in a variety of hair and skin consumer products, and functions to reduce the surface tension of water allowing the product to spread and penetrate easier. It should also be noted that sodium lauryl sulfate is relatively inexpensive in nature, providing an additional benefit to the present invention.

The compound of the present invention is a foliar active weed control formula for non-selective control of herbaceous broadleaf and grass weeds. Thus, one distinction of the present invention is its departure from the selective aspects common to the prior art. Foliar contact with the compound causes rapid desiccation of plant and weed leaves, essentially burning the same from the top down. This is distinguished from common prior art compounds and systemic plant killers, which often interfere with plant enzymatic processes, and stop the plant from producing food.

The components of the formula work in a synergistic manner to effectively kill broadleaf weeds and grasses. As such, the present invention can be effectively used in areas such as sidewalks, paths and walkways, driveways, landscaped areas including those with mulch and gravel, along fences, and around trees, shrubs, flowers, or vegetable gardens. In addition, it should be noted that the aforementioned usage may be residential, industrial, commercial or municipal in nature.

Regarding the speed with which the formula is effective, results in the form of wilting and/or browning of the subjects can be seen in as little as one hour after application. In addition, rainfall as soon as one hour after application will not adversely affect the performance of the compound. As such, this provides yet another advantage over the traditional weed and grass killers of the prior art.

Regarding other benefits provided by the present invention, the pesticide-free, natural-based formulation will not pollute ground waters, as is frequently the case with the herbicides of the prior art. In addition, soil pH and microorganisms are not affected by usage of the present invention, providing yet another benefit typically unavailable.

With regard to the Environmental Protection Agency, its regulations, and its mandate on relevant product labeling, the active and inert ingredients of the present compound are considered to be “GRAS” (Generally Regarded as Safe) by the EPA, and products formulated exclusively from these ingredients are exempt from EPA registration. More particularly, the present formulation is comprised exclusively of active and inert ingredients from the “Minimum Risk Exempted Products” and “Permitted Inerts lists.” The EPA considers pesticide-free, exempt herbicides to be safe for public use and, consequently, does not require the detailed warnings on exempt product labels that are commonly found on registered product labels. Indicative of the safeness of the exempt compounds is the fact that applicators of EPA Exempt products do not require licensing in most states.

Therefore, in total, the present invention provides an effective and natural herbicidal composition to be applied to vegetative growth to achieve a complete kill thereof.

With regards to all descriptions and graphics, while the invention has been illustrated and described as embodied, it is not intended to be limited to the details shown, since it will be understood that various omissions, modifications, substitutions and changes in the forms and details of the device illustrated and in its operation can be made by those skilled in the art without departing in any way from the spirit of the invention.

Without further analysis, the foregoing will so fully reveal the gist of the present invention that others can readily adapt it for various applications without omitting features that, from the standpoint of prior art, constitute essential characteristics of the generic or specific aspects of this invention. What is claimed as new and desired to be protected by Letters Patent is set forth in the appended claims.

What is claimed is:

1. A pesticide-free weed and grass killer comprising:
a water-based herbicidal formulation utilizing sodium lauryl sulfate as a surfactant;
and utilizing acetic acid, providing a natural herbicidal composition to be applied to vegetative growth to achieve a complete kill thereof.

2. The pesticide-free weed and grass killer as described in claim 1, wherein the formulation further utilizes NaCl as an active ingredient.

3. The pesticide-free weed and grass killer as described in claim 1, wherein the formulation further utilizes Sorbitol as a means to aid in absorption and stabilization.

4. The pesticide-free weed and grass killer as described in claim 1, wherein the formulation utilizes acetic acid as an active ingredient.

5. The pesticide-free weed and grass killer as described in claim 1, wherein the formulation utilizes acetic acid as an inert ingredient.

6. The pesticide-free weed and grass killer as described in claim 1, wherein the formulation utilizes acetic acid in a range of 3% to 10%.

7. The pesticide-free weed and grass killer as described in claim 1, wherein NaCl is of a range of 2% to 10%.

8. The pesticide-free weed and grass killer as described in claim 1, wherein Sorbitol is of a range of 1% to 5%.

9. The pesticide-free weed and grass killer as described in claim 1, wherein sodium lauryl sulfate is of a range of 0.01% to 0.25%.

10. The pesticide-free weed and grass killer as described in claim 1, wherein the formula is used in conjunction with sidewalks paths and walkways, driveways, landscaped areas with mulch and gravel, along fences, and around trees, shrubs, flowers, and vegetable gardens.

11. The pesticide-free weed and grass killer as described in claim 1, wherein the formula is used in residential, industrial, commercial or municipal areas.

12. The pesticide-free weed and grass killer as described in claim 1, wherein the formula is EPA exempt, as all ingredients are Generally Regarded As Safe.
